(19) United States
(12) Patent Application Publication
(10) Pub. No.: US 2004/0113937 A1
(43) Pub. Date: Jun. 17, 2004

(54) Method and apparatus for improved computer-aided facilities management

(76) Inventors: David M. Sawdey, Wilmette, IL (US); Richard G. Hunt, Grayslake, IL (US)

Correspondence Address: Christopher N. George, McAndrews, Held & Malloy, Ltd., 34th Floor, 500 West Madison Street, Chicago, IL, 60661, US

(21) Appl. No.: 10/318,037

(22) Filed: Dec. 13, 2002

(51) Int. Cl. G09G 5/00

(52) U.S. Cl. 345/738

(57) ABSTRACT

Certain embodiments of the present invention provide a system and method for dynamic integrated computer-aided facilities management. The method includes selecting a resource to view and retrieving data relating to the resource. The method also includes generating an interactive graphic representing the resource from the data, incorporating links to the data in the interactive graphic, and outputting the interactive graphic. The method may also include converting a standard graphics file into data for use in generating the interactive graphic. The system includes a user interface for requesting a graphic representing a resource, a data source comprising data related to the resource, and a graphics generator for dynamically generating an interactive graphic representing the resource. The interactive graphic is generated from the data in the data source. The interactive graphic allows a user to view data relating to the resource within the interactive graphic.

### BACKGROUND OF THE INVENTION

The present invention generally relates to computer-aided facilities management. More specifically, the present invention relates to dynamically integrating graphical representations with facilities information in computer-aided facilities management (CAFM).

A wide variety of resources are associated with businesses and organizations. Office space, furniture, computing and communication resources, personnel, products, and other equipment, for example, are important resources for businesses and organizations to monitor. Resources may be displayed graphically using schematics or floor plans, for example. Information regarding resources may be listed in a text format separate from the schematics.

Infrastructure and resource data is necessary for a functioning organization. For example, moving one person from point A to point B may involve coordination of several departments. If an employee moves from one office to another, for example, human resources, facilities, telecommunications, information technology, purchasing, and security operations may all need some information to smoothly coordinate relocation.

Computer-aided facilities management (CAFM) (also known as computer-integrated facilities management (CIFM)) systems track and manage information about a facility. Typical information that is tracked includes offices, computer workstations, personnel, cabling, and assets. Current solutions simply display an image showing some information. Current CAFM/CIFM systems do not allow users to interact dynamically with their organization's data via vector graphics. Current methods also do not allow users to add, edit, and/or delete data easily. A need exists for an organization's data to be graphically displayed so that users may more easily understand the organization's information and how the information and resources interrelate.

Current facility schematics are often constructed in formats such as AutoCAD® or DXF™ drawing interchange file format, for example. Such tools allow for a two- or three- dimensional representation of resources or components. Additional information describing the resource or component must currently be furnished separately in a text format or database.

Traditionally, changes in resource allocation must be made separately in, both the diagram and in the text description. Often, the text description is updated without correcting the diagram. An outdated diagram or text reduces the usefulness of resource tracking. Additionally, outdated schematics or text may result in errors when a user relies on the information in the schematics and/or text.

Therefore, a system that dynamically integrates information regarding resources with a graphical representation of the resources would be highly desirable. A method that dynamically updates both graphical and textual descriptions of resources would also be highly desirable. There is a need for a system and method that dynamically synchronizes access and modification of an organization's resources.

### BRIEF SUMMARY OF THE INVENTION

Certain embodiments of the present invention provide a system and method for dynamic integrated computer-aided facilities management. The method includes selecting a resource to view and retrieving data relating to the resource. The method also includes generating an interactive graphic representing the resource from the data, incorporating links to the data in the interactive graphic, and outputting the interactive graphic. The method may also include converting a standard graphics file into data for use in generating the interactive graphic. The method may also include performing data validation tests on the data before generating the interactive graphic.

In an embodiment, the links in the interactive graphic may include web-based script hooks to the data. A user may select a section of the interactive graphic to view data relating to the section. A user may modify the interactive graphic using an interface. The interactive graphic represents at least one of a floor plan, a building stacking plan, a data center cabinet elevation, a network connectivity diagram, cable management diagram, an asset report, and a schematic.

The system includes a user interface for requesting a graphic representing a resource, a data source comprising data related to the resource, and a graphics generator for dynamically generating an interactive graphic representing the resource. The interactive graphic is generated from the data in the data source. The interactive graphic allows a user to view data relating to the resource within the interactive graphic. The system may further include a web-based user interface.

In an embodiment, the data source is a relational database. The interactive graphic may be a scalable vector graphic. The graphics generator may convert a vector graphics file into data in the data source. In one embodiment, the graphics generator may also perform data validation tests. In an embodiment, the user interface allows a user to modify the interactive graphic. A user may select a portion of the interactive graphic using the user interface and view data relating to the portion.

In a certain embodiment, a method for dynamically generating an interactive graphical representation of a resource includes opening a first graphic file, extracting graphic information from the first graphic file, creating an interactive graphic file, converting contents of the first graphic file to an interactive graphic format, copying converted contents of the first graphic file to the interactive graphic file, and adding web-based scripts to relate informational data to portions of image data in the interactive graphic file. The interactive graphic format may be a scalable vector graphic format. The method may also include displaying the interactive graphic file. The method may further include storing the converted contents in a database. Additionally, the method may include dynamically generating an interactive graphic using the database.

### BRIEF DESCRIPTION OF SEVERAL VIEWS OF THE DRAWINGS

FIG. 1 illustrates a computer-aided facilities management (CAFM) system used in accordance with an embodiment of the present invention.

FIG. 2 illustrates a workflow model to update an asset location table in a data source in accordance with an embodiment of the present invention.

FIG. 3 illustrates a method for dynamic computer-aided facilities management used in accordance with an embodiment of the present invention.

FIGS. 4a and 4b illustrate a method for converting a vector file into a SVG file for dynamic graphical representation of a resource in accordance with an embodiment of the present invention.

FIG. 5 illustrates a building floor plan in accordance with an embodiment of the present invention.

FIG. 6 shows a relationship between building occupancy data and a floor plan in accordance with an embodiment of the present invention.

FIG. 7 illustrates an example of information available for a workstation in a building floor plan used in accordance with an embodiment of the present invention.

FIG. 8 illustrates an example of an interactive workstation graphic that allows a user to find a workstation and view/change information regarding the workstation in accordance with an embodiment of the present invention.

FIG. 9 depicts a building stack plan in accordance with an embodiment of the present invention.

FIG. 10 illustrates a data center cabinet elevation used in accordance with an embodiment of the present invention.

FIG. 11 shows sample screen shots of data validation tests in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention may be used to help an organization plan, track, and manage its infrastructure and resources. Certain embodiments use web-based technologies to graphically display information from a data source. Certain embodiments use scalable vector graphics (SVG) to relate data to graphics. SVG may be used to explain relationships within data. Graphics are generated dynamically upon request. Information is read from a data source and converted into a graphic that a user may understand and use.

Dynamic creation of a resource graphic produces a graphic that exactly represents the current information in the database. Current manual solutions are not dynamic and often produce graphics that are inconsistent with the data. Dynamic generation of the graphic from the data ensures that the graphic will always be synchronized with the data.

In one embodiment of the present invention, a vector file is converted to an SVG file representing a resource. Data related to the resource is dynamically linked or added to the SVG file from a data source. The SVG graphic and data for the resource are displayed for user interaction.

In another embodiment of the present invention, an SVG file is dynamically generated based on resource data from a data source. An SVG file template is used to dynamically construct an SVG file representing a resource including links to data related to the resource. The SVG graphic and data for the resource are displayed for user interaction.

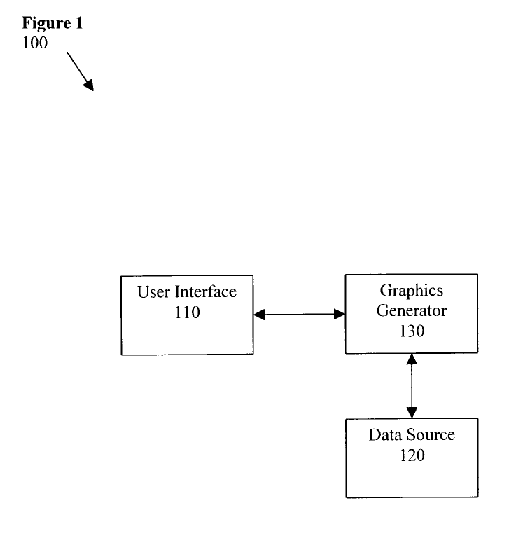

FIG. 1 illustrates a computer-aided facilities management (CAFM) system 100 used in accordance with an embodiment of the present invention. The system 100 includes a user interface 110, a data source 120, and a graphics generator 130. The components of the system 100 may be embodied in separate units or may be combined. The components of the system 100 may be connected by a network connection, cable, infrared, wireless, or other data connection, for example. The components of the system 100 may be software and/or hardware.

The user interface 110 allows a user to interact with the graphics generator 130 and the data source 120 to generate a graphical representation of a resource, such as a floor plan, along with data relating to the resource. The user interface 110 allows a user to select a resource. The user interface 110 may allow customization of a resource graphic and data associated with the resource graphic. For example, a user may be able to select a floor in a building for display via a web browser user interface 110. The user may select a first floor layout and may request information regarding wiring and computer infrastructure on the first floor. The requested graphic and associated data are available for user interaction via the user interface 110. For example, a user requests a floor plan via a web browser on a personal computer, and the floor plan is displayed via the web browser. The user may interact with the graphic to retrieve the data using the web browser. The graphic and associated data may also be displayed on a separate output, printed, transmitted via electronic mail, and/or transmitted via facsimile, for example. The user interface 110 may be a personal computer or other terminal, a handheld computer, a cellular phone, a web browser, or other interface, for example.

The data source 120 includes data relating to resources in a facility. The data source 120 may be a relational database (such as Microsoft Access, Microsoft SQL, Oracle, or Sybase), a spreadsheet, XML (Extensible Markup Language) document, text file, SVG file, or other data file, for example. The data in the data source 120 provides information regarding resources. The data in the data source 120 is assigned to a resource or workspace. Data may include space, personnel, equipment, assets, cabling, doors, keys, emergency data, business data, and other infrastructure and resource data, for example. Different types of data may have several associated pieces of information. For example, space data may include information such as area, type, department assigned, occupant, and asset location, for example. Cabling data may include cable and port management and other wiring data, for example. Asset data may include characteristics such as asset type, asset number, purchase date, cost, and maintenance history, for example.

In an embodiment, the data source 120 includes a device and asset symbol library. The library may be a table including field for symbol name, description, DXF™ text, SVG text, and symbol specifications, such as power requirements, heat output, width, height, and depth, for example. DXF™ is the format used by AutoCAD® to store a standard two-dimensional graphical image. SVG is a graphical subset of XML that allows two-dimensional graphics to be represented using XML. SVG allows graphics to be animated, interactive, and/or dynamic. SVG allows web-based scripts, for example, to be incorporated with the SVG graphic. An SVG file may include graphics data and text data.

The graphics generator 130 generates a graphic that represents a resource. The graphics generator 130 may include hardware and/or software. The graphics generator 130 extracts symbols, for example, from the data source 120 to build a graphical representation of a resource. For example, symbols may be used to generate a data center cabinet elevation graphic, a network connectivity diagram, a schematic, and/or a vector image of the symbol, for example. SVG graphics are dynamically parsed (merged) from a symbol or plurality of symbols to generate a resource graphic.

Thus, SVG graphics of resources, such as devices and assets, may be dynamically generated by the graphics generator 130 based on information from the data source 120. Dynamic generation of the graphic from data in the data source helps to ensure that the graphical representation is not out of sync with the data source 120. Users may dynamically interact graphically with an organization's data using web-based or other languages such as XML, SVG, VML, ASP, XHTML, DHTML, XSL HTML, Java, JavaScript, VBScript, C#, or Net, for example.

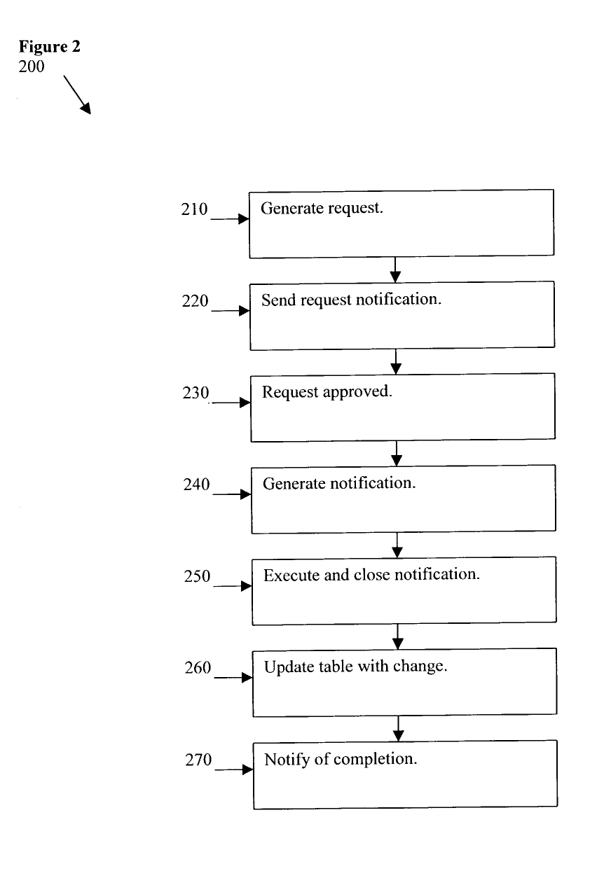

The system 100 accommodates updates of data in the data source 120. In one embodiment, for example, the system 100 includes a workflow model 200 to update an asset location table in the data source 120. The workflow model 200 is shown in FIG. 2. First, at step 210, a request is generated (by a user, for example) to place a new asset, change an existing asset, or move an existing asset, for example. Then, at step 220, a request notification is sent (to a hardware and/or software asset coordinator for example). At step 230, the asset request is approved. Additionally, the asset placement or change is confirmed.

Next, at step 240, a notification, such as a work ticket, is generated and transmitted to appropriate parties. Then, at step 250, the notification (e.g., work ticket) is executed and submitted and closed and completed. At step 260, the asset location table is updated with the change. Finally, at step 270, the appropriate parties are notified that the work ticket, for example, is closed.

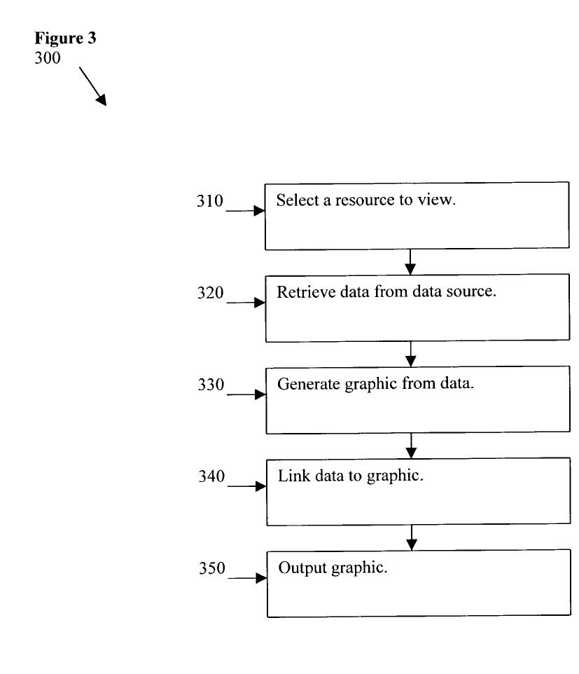

FIG. 3 illustrates a method 300 for dynamic computer aided facilities management used in accordance with an embodiment of the present invention. First, at step 310, a user selects a resource to view. For example, a user selects a device to view in a data center cabinet elevation using a user interface 110, such as a web-based user interface, on a personal computer. Next, at step 320, data regarding the selected resource is retrieved from a data source. For example, the graphics generation engine 130 retrieves data for the device from the data source 120.

Then, at step 330, a graphic is generated from the data. For example a SVG graphic representing the device is generated from the XML data in the data source 120 by the graphics generation engine 130. At step 340, the data regarding the resource is linked to the graphic representing the resource. For example, links to device details are placed in the device graphic by the graphics generation engine 130.

Finally, at step 350, the resource graphic is output. For example, the data center cabinet elevation and device graphic is displayed via the user interface 110, such as a web browser and monitor, of the personal computer. A user may interact with the graphic to view data related to segments or portions of the interactive graphic. A user may also add, delete, and/or modify the graphic and/or the data using the user interface 110.

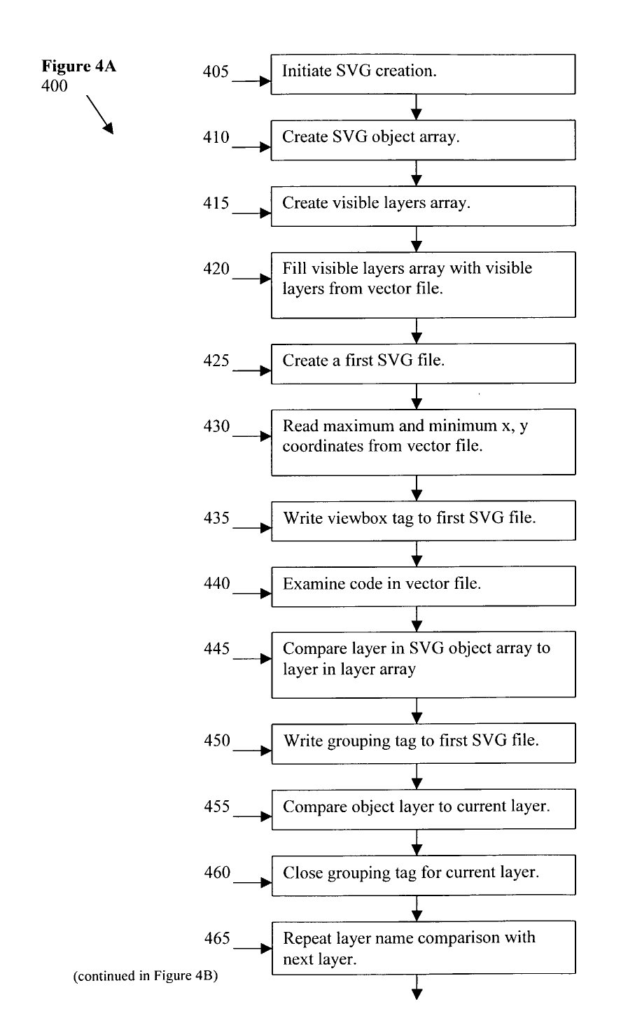

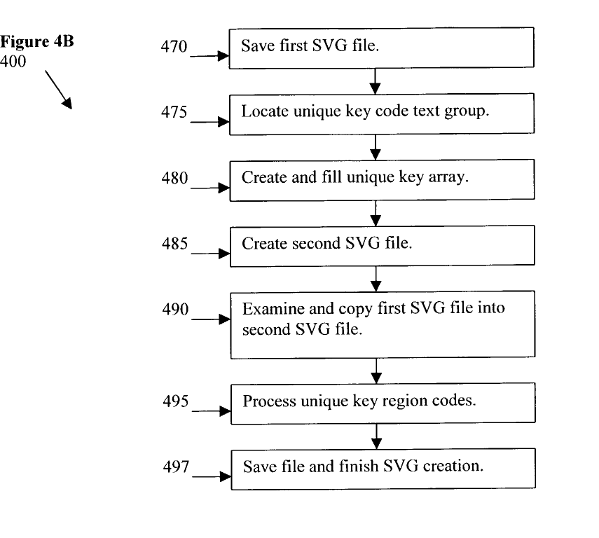

FIGS. 4a and 4b illustrate a method 400 for converting a vector file into a SVG file for dynamic graphical representation of a resource in accordance with an embodiment of the present invention. The graphical representation is generated from a vector file, such as a vector file depicting a floor plan, in the data source 120. The vector file may be converted from another vector file format.

First, at step 405, SVG creation is initiated. In an embodiment, a SVG creator application is started. A configuration file is read. The configuration file (such as a .ini, .xml, or .db file, for example) includes a location of a compression/decompression application, a name of a layer in the vector file in which to find key code text, a name of a layer in the vector file in which to find key regions (such as polylines, for example), and a location in which to create and store a new SVG file, for example.

Then, at step 410, a multi-dimensional SVG object array is created. The multi-dimensional SVG object array stores the layer name and SVG code equivalent of information objects in the vector file. At step 415, a single-dimensional visible layers array is created. The single-dimensional array lists all visible layers in the vector file. At step 420, the visible layers array is filled with visible layers extracted from the vector file.

Next, at step 425, a first SVG file is created. For example, a new SVG file may be created using File System Objects. Standard SVG header information is written to the first SVG file. Then, at step 430, the maximum x-coordinate, maximum y-coordinate, minimum x-coordinate, and minimum y-coordinate are read from the vector file. At step 435, the coordinates are used to add a viewbox tag to the first SVG file. The viewbox tag maximizes the SVG graphic and positions the SVG graphic in a viewable window for display.

At step 440, code in the vector file is examined. Code in the vector file is read line by line. If a code line does not refer to an object, then the next code line in the vector file is examined. If the code line refers to an object but the object is not on a visible layer, then the next code line in the vector file is examined. If the code line refers to an object that is on a visible layer, then the vector object code is read. The vector object code is converted into an equivalent SVG code. For example, a line vector object converts to a line in SVG. A text vector object converts to text in SVG. A polyline, arc, or solid vector object convert to a polyline in SVG. A circle vector object converts to a circle in SVG. Additionally, properties of a vector object may be saved with the converted object in the first SVG file. For example, line weight, font type, and size may be saved with the SVG object. The SVG object code and associated layer name are written to the visible layers array. Then, the next code line is examined.

After all objects are converted and written to the visible layers array, the array is parsed and written to the first SVG file. At step 445, SVG object properties for a layer in the visible layers array are read from the configuration file. If no properties exist for the current named layer, then default properties are used. Then, at step 450, a grouping tag corresponding to the current layer is written in the first SVG file. At step 455, layers in the SVG object array are compared to the current layer from the visible layers array. If the object's layer name does not match the layer name from the visible layers array, then the next object in the SVG object array is examined. If the object's layer name does match the layer name from the visible layers array, then the SVG code for the object is written in the first SVG file. Then, the next object in the SVG object array is examined. At step 460, when all of the objects in the SVG object array have been compared to the current layer, the grouping tag for the current layer is closed. Then, at step 465, the layer name comparison is repeated with the next layer in the visible layers array. Layer properties, grouping tags, and matching objects are written in the first SVG file for each layer in the visible layers array.

At step 470, when the end of the visible layers array is reached, the first SVG file is saved. Then, at step 475, a unique key code text group tag is located in the first SVG file. Next, at step 480, a multi-dimensional unique key array is created and filled with an x-coordinate, y-coordinate, and unique key code text of each tag in the unique key code text group tag of the first SVG file. Then, the first SVG file is again saved.

Next, at step 485, a second SVG file is created. At step 490, the first SVG file is examined and copied line by line into the second SVG file. At step 495, unique key region codes are processed. If a unique key code region tag is found in the first SVG file, all of the x,y vertices of the object are extracted. The unique key array is searched for unique key code text corresponding to the x,y coordinates. A match indicates that the x,y coordinates are inside the current SVG object. If the x,y coordinates of the unique key array are inside the object, a JavaScript function is parsed into the SVG object with the unique key value and layer name as variables for the function. The unique key value is parsed as an ID attribute to the SVG object. The new SVG object code line is written to the second SVG file. Then, the next line of the first SVG file is examined.

Additionally, the code lines are examined to identify unique key code text tag lines. The JavaScript function is parsed into each unique key code text tag. In an embodiment, the JavaScript function is inserted as an “href” html code into the unique key code tag. The variable value for the JavaScript function is the unique key value in the unique key code tag.

At step 497, after the second SVG file has been written, the SVG files are closed, and SVG creation is completed. The second SVG file graphically represents a resource. The second SVG file may be displayed for a user. The user may interact with the second SVG file to view information in the unique key code text regarding components of the resource graphic. Thus, a floor plan graphic, for example, may be converted to an SVG floor plan graphic. Data from the data source 120 may be dynamically linked to the SVG graphic for interactive access by a user.

Certain embodiments of the present invention relate to a method and system for planning and managing an organization's infrastructure by connecting data to an interactive graphics file, such as a SVG. Space management, personnel tracking, asset management, and cable management, for example, may be facilitated by certain embodiments. SVG's may be created dynamically. That is, SVG's may be created from data on request. Preferably, a new graphic is created each time a user requests a resource graphic. The infrastructure is managed dynamically and interactively using SVG.

Thus, certain embodiments create/convert files to SVG files and connect data to an SVG. JavaScript functions, for example, are inserted into the SVG to create hooks to dynamically display data and color code the SVG based on the data. A user may view the graphic and interact with the SVG to obtain information regarding components of the graphic. Interactive SVG's may dynamically represent building floor plans, building stacking plans, data center cabinet elevations, networking diagrams, reports with pictures of each asset, cable management, aircraft schematics, work orders, schedules, or other resource graphics, for example.

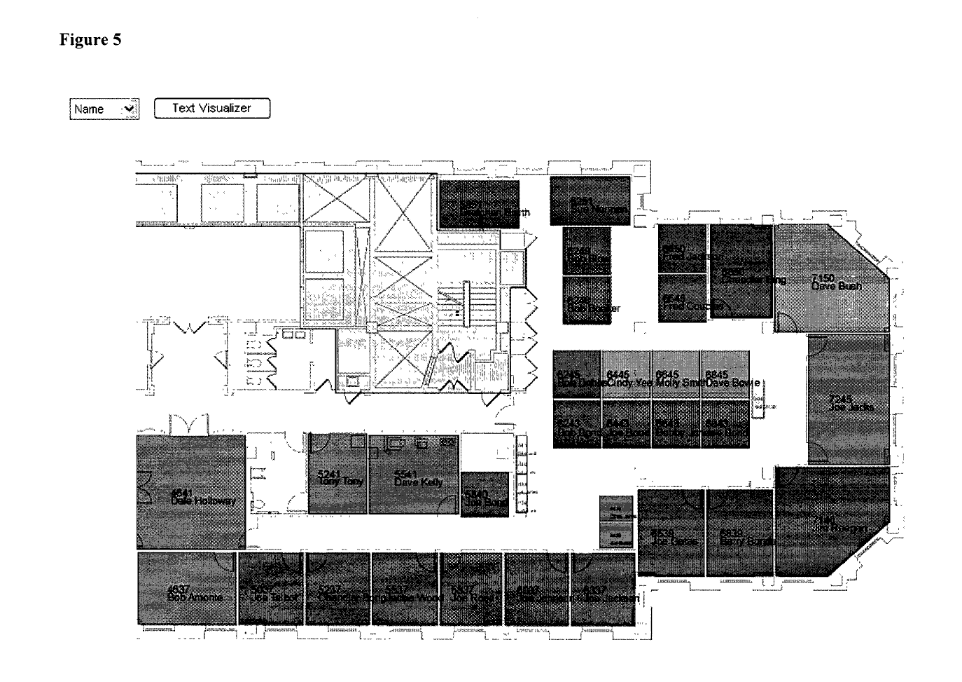

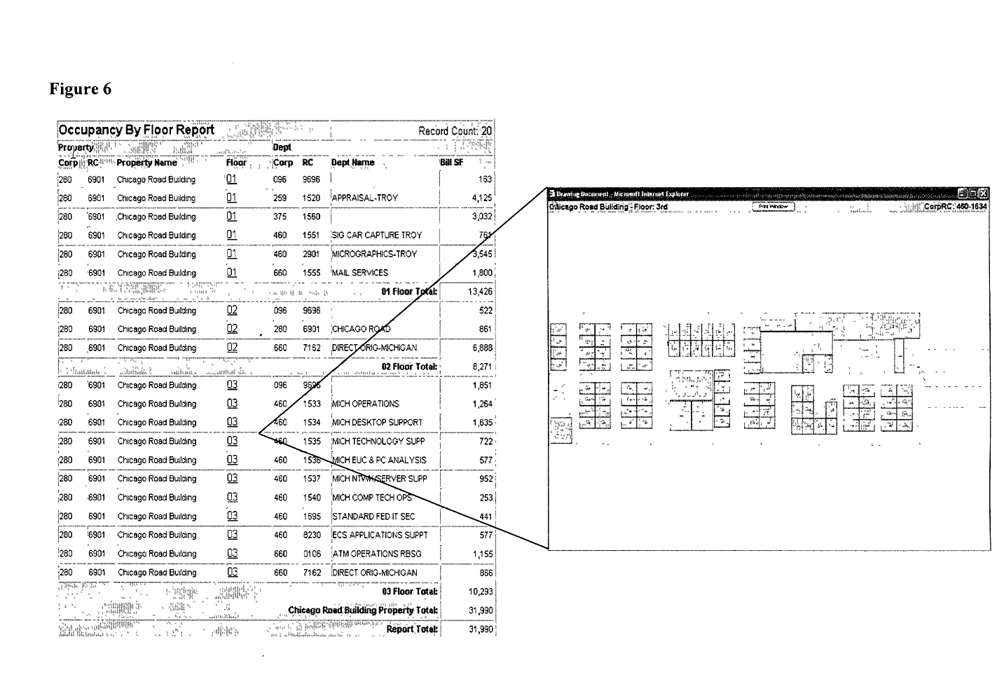

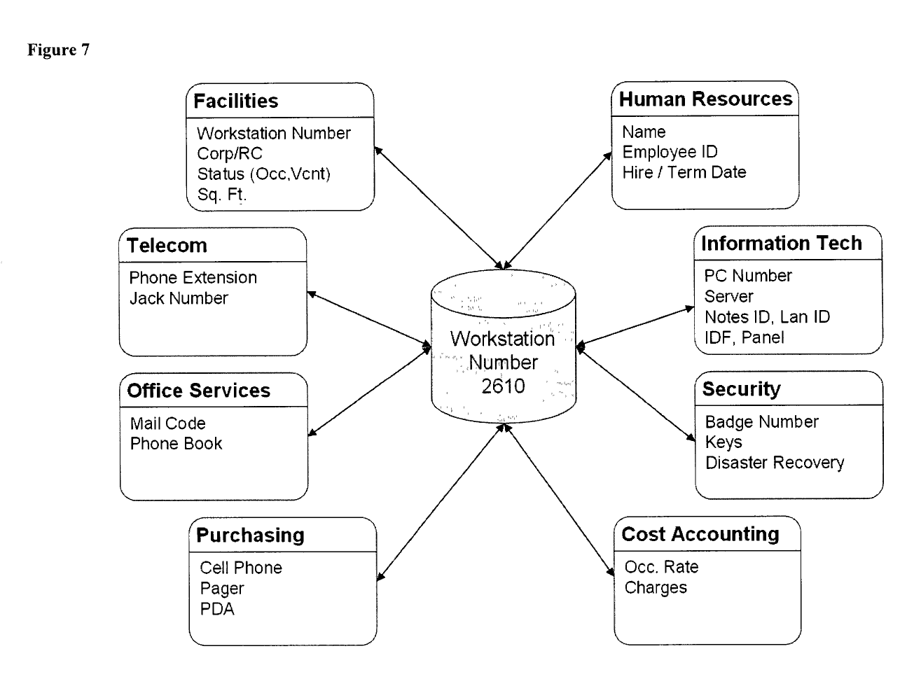

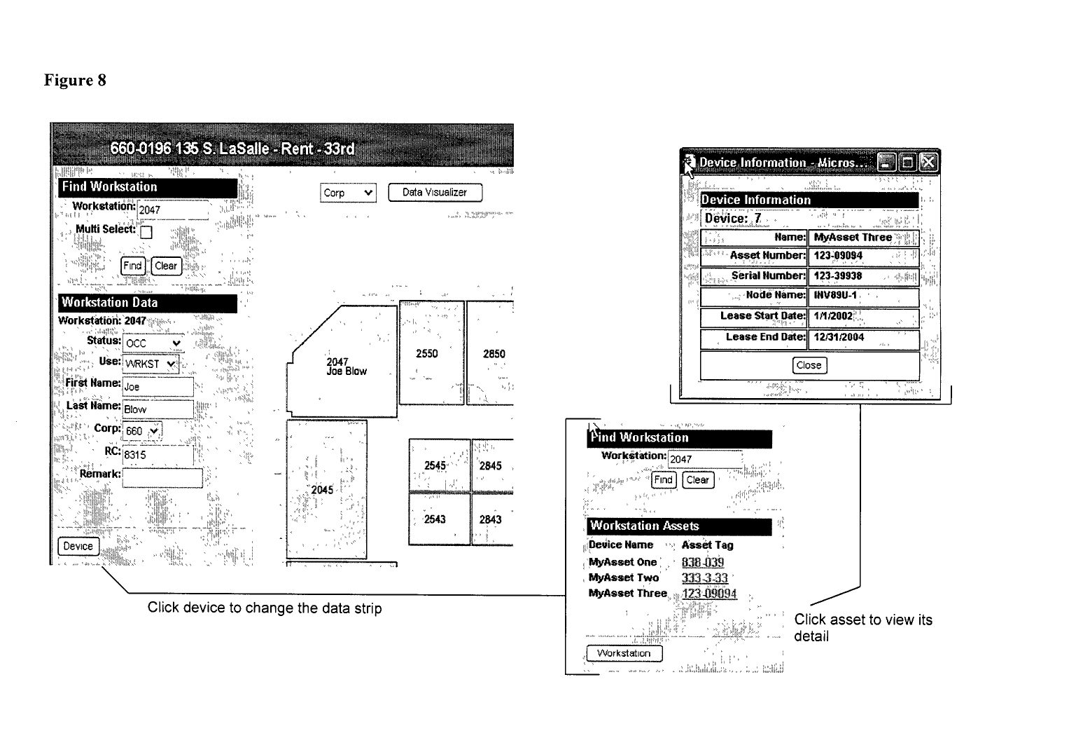

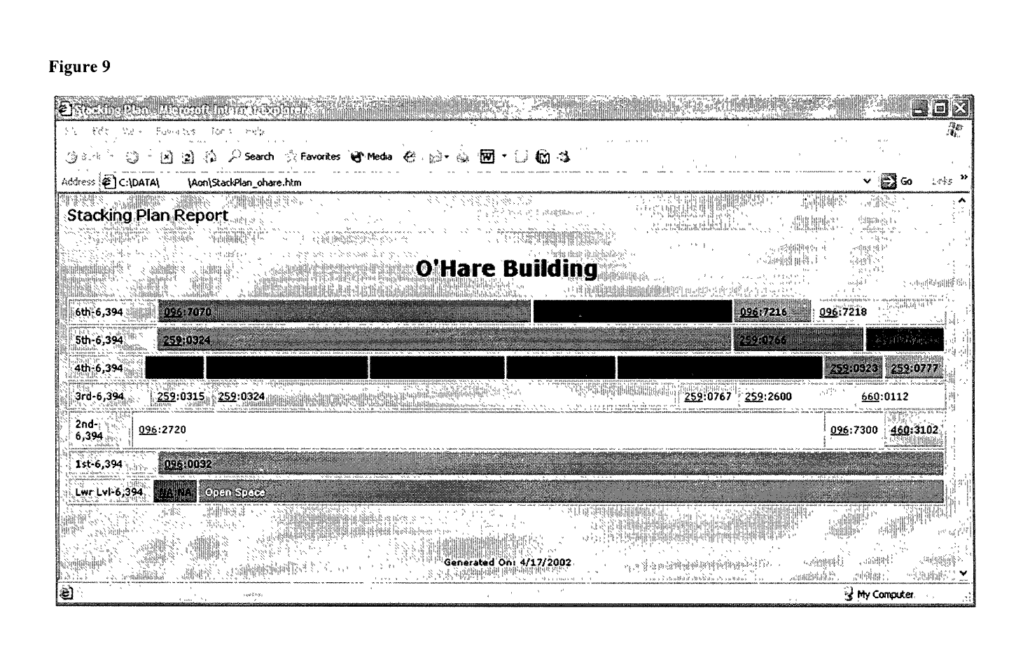

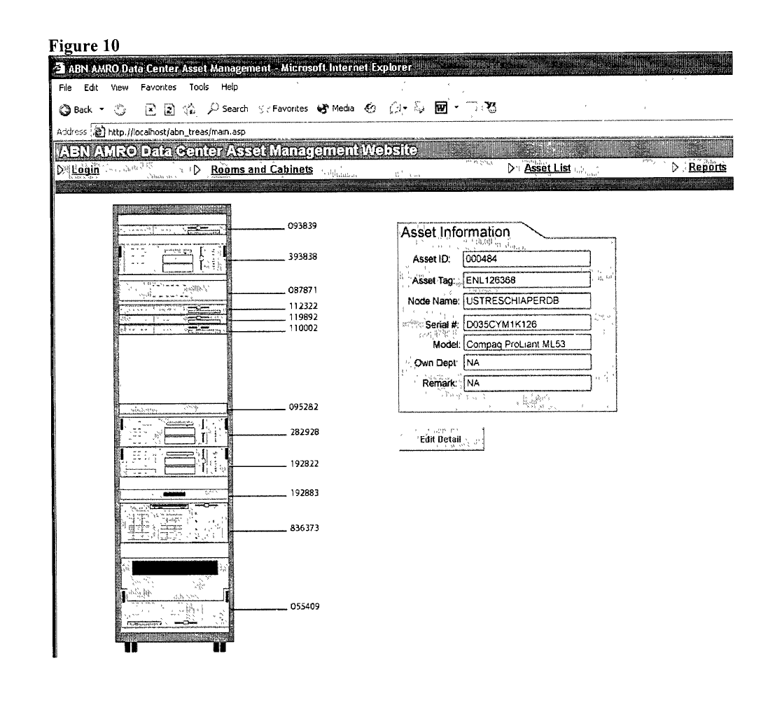

FIGS. 5-10 illustrate exemplary graphics and information available in accordance with certain embodiments of the present invention. FIG. 5 illustrates a building floor plan in accordance with an embodiment of the present invention. A user may click on an office or workstation location to retrieve information about the office. FIG. 6 shows a relationship between building occupancy data and a floor plan in accordance with an embodiment of the present invention. FIG. 7 illustrates an example of information available for a workstation in a building floor plan used in accordance with an embodiment of the present invention. For example, the information in FIG. 7 may be obtained in a floor plan graphic such as the floor plan depicted in FIG. 5. FIG. 8 is another example of an interactive workstation graphic that allows a user to find a workstation and view/change information regarding the workstation. FIG. 9 depicts a building stack plan in accordance with an embodiment of the present invention. The building stack plan details floor occupancy, for example, by floor in a building. The building stack plan may allow a user to retrieve information about a floor and its occupants. FIG. 10 illustrates a data center cabinet elevation used in accordance with an embodiment of the present invention. The data center cabinet elevation allows a user to view and manage data center assets, for example.

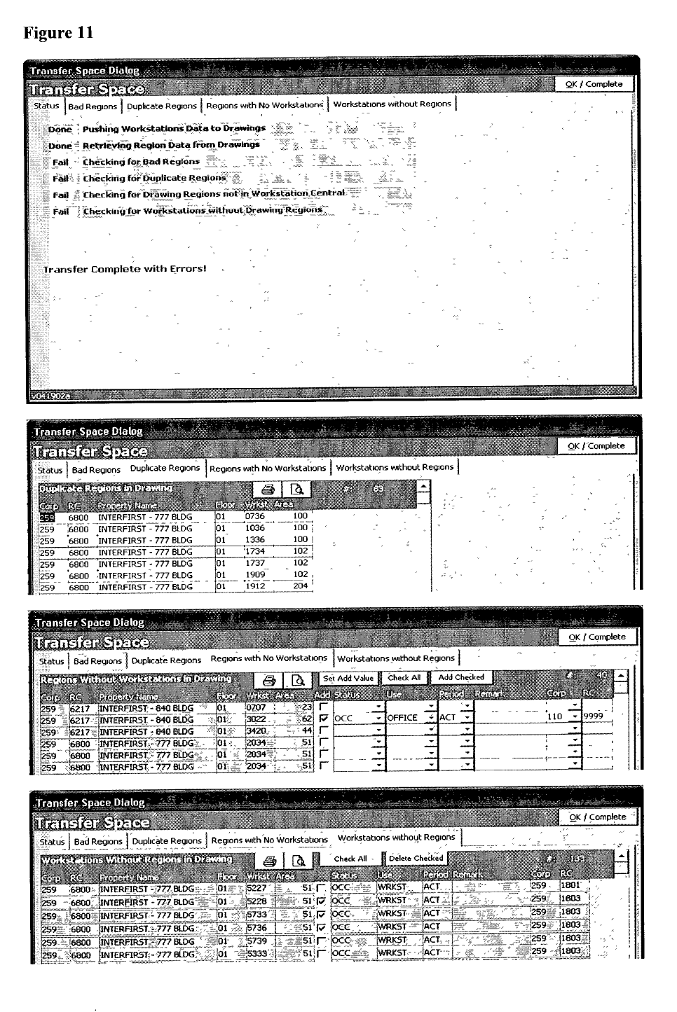

In an embodiment, an SVG file may be read and used to populate a database table with all of the unique key regions and corresponding area. After capturing unique key region numbers and areas in the database table, data validation tests may be run. Data validation tests may check unique key region numbers to locate duplicate numbers. Data validation tests may also check for unique key region numbers that do not have a corresponding record in a live database regions table (drawing regions without database records). Additionally, data validation tests may check for live database region records that do not have a corresponding record in the SVG file's unique key region numbers (database records without drawing records) or for valid region areas (areas that have a valid region, a valid area value, etc.). FIG. 11 shows sample screen shots of some data validation tests in accordance with an embodiment of the present invention.

In certain embodiments, personnel, for example, are moved, added, deleted, or changed using floor plans created using SVG. Additionally, assets are created, tracked, and managed efficiently and effectively. Relationships between assets may also be graphically represented. For example, a cabinet housing an asset may be highlighted on a floor plan in SVG. Also, a network connectivity diagram may be dynamically created highlighting the selected asset, for example.

Certain embodiments dynamically color code SVG floor plans based on data from the data source 120 (known as data visualization). The data is typically stored in a database but may also be collected from a text document, spreadsheet, or other file format. Text from the data source 120 may also be dynamically linked to and displayed on a SVG floor plan (called text visualization).

Graphical asset management dynamically creates SVG files from information included in an outside data source 120. A user may click, highlight, roll over and/or select with a computer mouse, for example, graphical items within the SVG to display information from the data source 120. For example, after a user clicks on a room in a floor plan graphic, a window may pop up to display information regarding the assignment and contents of the room. Since the graphic and data “hooks” are generated automatically and dynamically, changes to data in the data source 120 are always present in the SVG viewed by the user.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for dynamically planning and managing resources, said method comprising:
selecting a resource to view;
retrieving data relating to said resource;
generating an interactive graphic representing said resource from said data;
incorporating links to said data in said interactive graphic; and
outputting said interactive graphic with said data.

2. The method of claim 1, further comprising converting a graphics file into data for use in generating said interactive graphic.

3. The method of claim 1, further comprising performing data validation tests on said data before generating said interactive graphic.

4. The method of claim 1, wherein said links comprise web-based script hooks to said data.

5. The method of claim 1, wherein a user selects a section of said interactive graphic to view data relating to said section.

6. The method of claim 1, wherein a user may modify said interactive graphic using an interface.

7. The method of claim 1, wherein said interactive graphic represents at least one of a floor plan, a building stack, a data center cabinet elevation, a network connectivity diagram, cable management, an asset report, and a schematic.

8. A method for dynamically generating an interactive graphical representation of a resource, said method comprising:
opening a first graphic file;
extracting graphic information from said first graphic file;
creating an interactive graphic file;
converting contents of said first graphic file to an interactive graphic format;
copying converted contents of said first graphic file to said interactive graphic file; and
adding web-based scripts to relate informational data to portions of graphic data in said interactive graphic file.

9. The method of claim 8, wherein said interactive graphic format comprises a scalable vector graphic format.

10. The method of claim 8, further comprising displaying said interactive graphic file.

11. The method of claim 8, further comprising storing said converted contents in a database.

12. The method of claim 11, further comprising dynamically generating an interactive graphic using said database.

13. The method of claim 12, wherein said interactive graphic represents at least one of a floor plan, a building stacking plan, a data center cabinet elevation, a network connectivity diagram, cable management, an asset report, and a schematic.

14. A computer-aided facilities management system, said system comprising:
a user interface for requesting a graphic representing a resource;
a data source comprising data related to said resource; and
a graphics generator for dynamically generating an interactive graphic representing said resource, said interactive graphic generated from said data in said data source, said interactive graphic allowing a user to view data relating to said resource within said interactive graphic.

15. The system of claim 14, wherein said user interface comprises a web-based user interface.

16. The system of claim 14, wherein said data source comprises a relational database.

17. The system of claim 14, wherein said interactive graphic comprises a scalable vector graphic.

18. The system of claim 14, wherein said graphics generator further converts a vector graphics file into said data in said data source.

19. The system of claim 14, wherein said graphics generator further performs a data validation test.

20. The system of claim 14, wherein said user interface allows a user to modify said interactive graphic.

21. The system of claim 14, wherein a user selects a portion of said interactive graphic using said user interface and views data relating to said portion.

22. The system of claim 14, wherein said interactive graphic represents at least one of a floor plan, a building stacking plan, a data center cabinet elevation, a network connectivity diagram, cable management, an asset report, and a schematic.

23. The system of claim 14, wherein said user interface allows a user to modify said data.

24. The system of claim 14, wherein said user interface allows a user to modify said data and save said data in said data source.

25. The system of claim 14, wherein said user interface allows a user to view said interactive graphic.
